(19) United States
(12) Patent Application Publication
(10) Pub. No.: US 2015/0026044 A1
(43) Pub. Date: Jan. 22, 2015

(54) METHOD, PROTOCOL AND SYSTEM FOR UNIVERSAL SENSOR COMMUNICATION

(71) Applicant: GAONIC LTD., Moshav Yarhiv (IL)

(72) Inventor: Rami Refaeli, Moshav Yarhiv (IL)

(21) Appl. No.: 14/324,274

(22) Filed: Jul. 7, 2014

Related U.S. Application Data
(60) Provisional application No. 61/843,392, filed on Jul. 7, 2013.

(51) Int. Cl. H04L 29/08; H04L 12/24; G06Q 20/38; G01D 11/00

(52) U.S. Cl. CPC H04L 67/12; G01D 11/00; H04L 41/22; G06Q 20/38
USPC 705/39; 715/736

(57) ABSTRACT

A system, protocol, network and method are herein provided. In some embodiments a system is provided for smart sensor management, including multiple sensor devices, each device being configured with an open platform API, an API integration layer, an open sense platform (OSP), and an interface layer.

### CROSS REFERENCE TO RELATED APPLICATIONS

This application claims priority from U.S. Provisional Application No. 61/843,392, filed 7 Jul. 2013, entitled “METHOD, PROTOCOL AND SYSTEM FOR UNIVERSAL SENSOR COMMUNICATION”, which is incorporated in its entirety herein by reference.

### FIELD OF THE INVENTION

The present invention relates in general to platforms, methods and devices useful in management of data from sensors.

### BACKGROUND OF THE INVENTION

Today, more than half the people on earth live in cities. In the coming years this number will continue to grow. In 2008 more than 50% of the world population lives in cities; by 2050 it will be 70% and in America 90%. These people are drawn by opportunity, by businesses that create new jobs and fresh ideas and by the promise of a lasting quality of life. They seek these things out not only for themselves, but for future generations as well. Cities use 60%-80% of the world's annual energy needs and account for 75% of greenhouse gas emissions. Lighting alone represent 19% of the world total electricity consumption. Cities therefore hold the essential key to reduce emissions.

There is a need to transform standard physical objects and entities into smart entities for example to enable enhanced monitoring, security, functionality, sustainability etc. In one example, smart cities are desirable to help these cities reduce their ecological imprint to a minimum by increasing their energy efficiency via means enabled by enhanced communications in such cities.

Against a backdrop of the economic crisis, sustainability is no longer optional, it is mandatory. Governments, Cities, business and people need to do more with less. Cities of today are shaped by their transport system, services, education and people. People want shorter commuting time, less energy consumption, reduced pollution and more cost efficient ways to go where they want to go.

It would be highly advantageous to have a system or method that could enable universal sensor communications and even a provision for a sensor related community.

### SUMMARY OF THE INVENTION

There is provided, in accordance with an embodiment of the present invention, an apparatus, system, and method to enable universal sensor communication. In some embodiments, the process for setting up such a system includes, Configuring multiple sensor devices with an open platform API; Configuring multiple sensor gateways with an open platform API; Setting up a sensor integration layer adapted to consolidate API related data from the sensors and/or sensor gateways; processing consolidated API data by an Open Sensor Platform (OSP) and providing the data to system users, via a user interface; and communicating between system users and connected sensor devices.

In further embodiments, the process further comprises integrating APIs from one or more social networks, for enabling sensor community communication.

In yet further embodiments, the OSP is designed to connect multiple sensor devices in an entity, thereby enabling Smart entity functionality by facilitating remote sensor data interaction.

According to some embodiments, a sensor communication protocol is provided, that includes: an API to interface with a sensor platform adapted to enable Auto provision to feed data to system without a user profile.

In some embodiments, the protocol of claim 4 enables a to take ownership of sensor data by identifying as the Sensor owner.

According to some embodiments, a method for sensor management is provided, comprising: connecting to an open sensor platform multiple sensor devices, using open platform APIs, wherein each sensor is provided with a sensor profile; connecting to the open sensor network multiple users, using an open sensor platform user interface; providing a user dashboard wherein users can determine platform settings; enabling each platform user to connect to each connected sensor, upon choice of such a sensor profile.

In a further embodiment, an user pays money to make use of a sensor's data.

In a further embodiment, an end user pays money to connect a sensor to the platform.

In a further embodiment, an end user may use platform tools to promote a selected sensor profile.

In still other embodiments, an end user pays money to promote a selected sensor profile.

In yet another embodiment, a sensor profile is displayed to the platform users in relation to the sensor's popularity.

In still another embodiment, sensors can communicate to one another.

According to some embodiments, a system is provided for smart sensor management, comprising: Multiple sensor devices, each device being configured with an open platform API; An API integration layer for consolidating the API data from the respective layers; an Open Sensor Platform (OSP) for connecting the respective sensors into the system, and for enabling users of the system to communicate with the respective sensors; and an interface layer for providing system users with an interface to interact with the system.

In further embodiments, the sensor management system further comprises a communication protocol being adapted to run is association with the open platform API to interface with the sensor platform.

In still further embodiments the communication protocol is adapted to enable Auto provision to feed data to system without a user profile.

In yet further embodiments, the sensor management protocol enables a user to take ownership of sensor data by identifying as the Sensor owner.

### BRIEF DESCRIPTION OF THE DRAWINGS

The principles and operation of the system, apparatus, and method according to the present invention may be better understood with reference to the drawings, and the following description, it being understood that these drawings are given for illustrative purposes only and are not meant to be limiting, wherein:

FIG. 1 is a schematic system diagram depicting components of a System for universal sensor communication, according to some embodiments;

FIG. 2 is a schematic diagram depicting an application layer of a Platform for universal sensor communication, according to some embodiments; and

FIG. 3 is a flow diagram indicating the process by which universal sensor communications are enabled, according to some embodiments.

### DETAILED DESCRIPTION OF THE INVENTION

The following description is presented to enable one of ordinary skill in the art to make and use the invention as provided in the context of a particular application and its requirements. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In other instances, well-known methods, procedures, and components have not been described in detail so as not to obscure the present invention.

The term “sensor” as used herein refers to any type of suitable detector or observer instrument, that may include but is not limited to sensors for measurement of temperature, touch, light, motion, temperature, magnetic fields, gravity, humidity, moisture, vibration, pressure, electrical fields, sound, other physical aspects of the external environment, biosensors, nanosensors, Smart Phones or others. See https://en.wikipedia.org/wiki/List_of_sensors for a list of sensors that may further be used.

According to some embodiments of the present invention, a Robust, reliable, low cost, easily deployed and sustainable Cloud based Open-Sense Platform (OSP) is provided, to read and share universal sensor data globally, enabling everyone to share and connect with any Thing, thereby enhancing what is known as the Internet Of Things (IoT). The OSP is adapted to enable autonomous sensors to be able to be discovered at different locations and to cooperatively pass their data through the network. The OSP may, in some embodiments, be operated as a PaaS (Platform-as-a-Service), where users will be able to make use of an independently maintained platform upon which their web applications, services and mobile applications can be built.

The OSP may be configured to enable secure, streamlined network management. Additionally it able to integrate several management, control, monitoring and configuration applications on top of the engine and the database with well-defined APIs. This modular approach helps with the commoditization of the platform and thus providing developers greater insight into features, technologies and products required by customers.

According to some embodiments, the OSP may integrate or be integrated into one or more social networks, where each stakeholder can share and follow sensors around the globe and get updated by events and history data.

According to some embodiments, a platform/system/method is herein provided to facilitate the setting up and management of Smart networks, such as smart cities, smart buildings, smart factories and other Smart Networks, by using an innovative platform solution for enhancing human-machine communications. The OSP as described herein is based on the deployment of an Open Smart Social Sensor Network (OSSSN) that is designed to bring substantial benefits to the population in terms of quality of life, enhance efficiency, better transport, decrease energy demand, reduction of pollution related illnesses and improving the efficiency and quality of the services provided by governing entities and businesses.

According to some embodiments, the OSP incorporates an essentially unlimited number of spatially distributed autonomous and discoverable sensors, to be able to monitor physical conditions at any number of locations, and to cooperatively pass their data through the OSSSN. The OSP is designed to enable a wide range of sensors to communicate and share information between stakeholders, and enabling users to regulate and optimize energy usage, traffic movements, communications, ways of doing business, and life styles in general. Users may use applications or computing interfaces to help communicate with system sensors from anywhere. The OSP also provides the back-office software platform to manage and control the installed sensors with a seamless visibility from the sensors to the controlling applications and management systems including AI/BI (artificial intelligence, Business Intelligent) platform that can analyze, manipulate the real-time data providing useful output to fully exploit the potential of the Internet-of-things.

According to some embodiments, the OSP is a scalable and flexible open sense platform that enables any third party to integrate their sensors with the platform and by that to leverage the power of collaboration amongst cities, researchers, vertical operations, corporations and citizens to co-create solutions to common challenges and opportunities.

In other embodiments, the OSP may support encrypted data using API's, Hijacking prevention, Data agnostics, and Secured Data sharing etc.

According to some embodiments, the OSP is a smart manager platform using cloud architecture. The OSP includes a proprietary engine which serves as the middleware (gatekeeper) for any connected sensor, and a dedicated database (instance) called the Server Machine. This database includes the relevant protocols and Application Programming Interfaces (APIs) for enabling usage and control of the various sensors or applications and providing templates such as web-based consoles. In this way, the sole requirement for adding, removing or updating system functionality is adding necessary APIs and Sensors data to the database—making use of the true and seamless Plug and Play architecture. The open sense platform enables secure, streamlined network management. Additionally, the OSP may integrate several management, control, monitoring and configuration applications, on top of the engine and the database, with well-defined APIs. This modular approach helps with the commoditization of the platform and thus providing developers greater insight into features, technologies and products required by customers. Examples of such products and applications include: Real time sensor(s) monitoring applications, Intelligent Smart City applications, Smart Lighting applications, Smart Parking application, Smart Real-Time traffic congestion applications, Infrastructure tools for IoT, Smart rubbish bin collection tools, eHealth tools and applications, Micro Grid and/or smart grid/water/gas applications, and others.

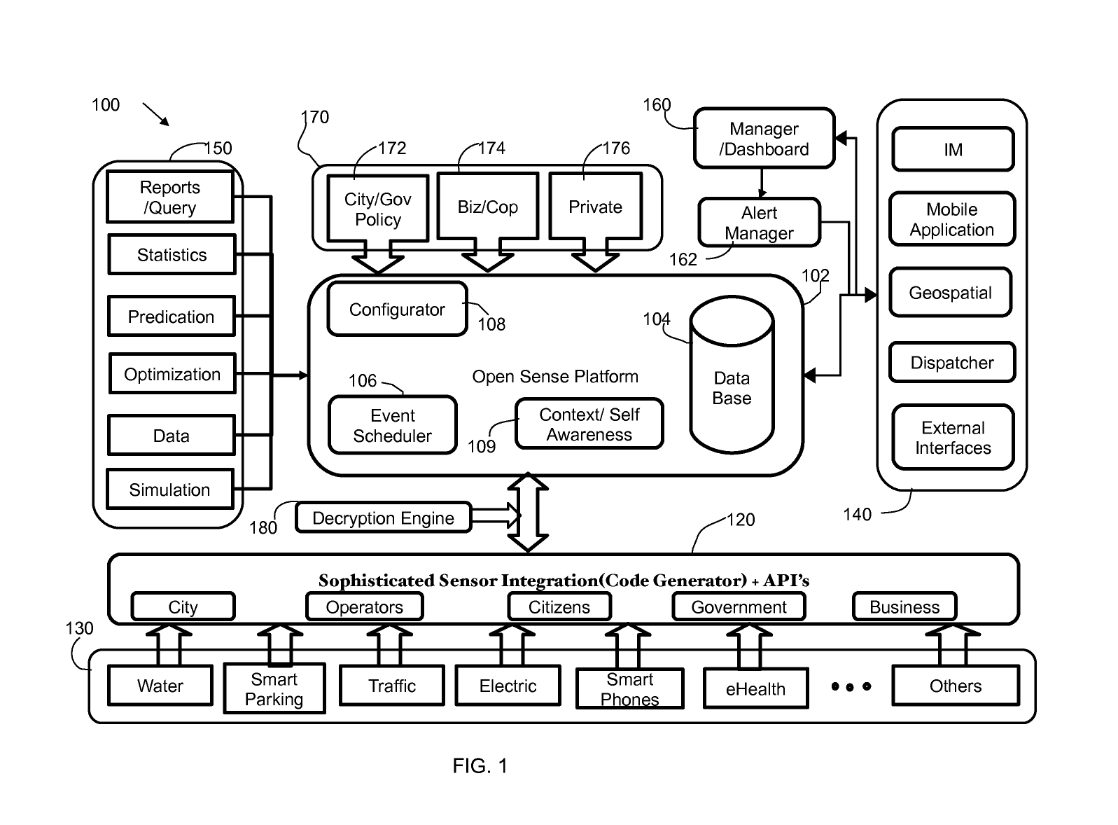

Reference is now made to FIG. 1, which is a schematic system diagram depicting an Open Smart Social Sensor Network (OSSSN) or system 100 for facilitating the universal communication and management of sensors, according to some embodiments. The system includes an Open Sense Platform (OSP) or sub-system 102, for enabling OSSSN software, hardware, applications etc. to be delivered and run. OSP 102 includes a file(s) with instructions to execute commands to enable execution of the OSSSN functionality, and is communicatively coupled to an OSP database 104, including a memory having stored thereon OSSSN and OSP related data, as well as platform user data, connected sensor data and more.

OSP 102 may further include an event scheduler 106. In some use cases, for example, scheduler 106 may be used to connect different yet related events, and schedule events etc.

OSP 102 may further include a Configurator 108. In some use cases, for example, configurator 108 may be used to configure the system roles in accordance with user policies, demands from the platform to the service users etc.

OSP 102 may further include a Context or Self Awareness module Configurator 109, to help provide contextual and/or self awareness to sensors.

OSSSN 100 further includes a sensor integration module 120, in communication with OSP 102. Sensor integration module 120 is enabled to receive, order and process sensor related data from sensor farms, sensor layers, computing systems 130 etc. In general, sensors 130 are provided with integrated or externally programmed Application Programming Interface(s) (APIs), to enable the sensors' recorded data to be sent to and processed by OSP 102. The OSP will than analyze the received data and recover the appropriate data to be uploaded to the Data Base. In some embodiments, the analyzing of received data may include executing machine learning algorithms, for example, to construct the relevant information, to prevent misuse of the platform, and to recognize the right pattern to be recorded in the OSP. Sensor integration module 120 may include an API reader/scanner/processor, or Sophisticated Sensor Integration element (not shown in the figure) configured to consolidate and integrate the sensor data received, whether from individuals, corporate entities, governing entities, Smart phones, etc. According to some embodiments, a code generator engine may be configured to automatically construct API's for particular sensor device or sensor categories, classes, types, makes etc.

OSSSN 100 further includes an Interface layer 140, for providing user friendly interfaces to users to interact with the platform. In some embodiments such interfaces may include instant messaging module(s), a dispatcher module, mobile applications, geo-spatial applications, CRM, Billing, Messenger or other external interfaces.

OSSSN 100 further includes a Wisdom or Intelligence layer 150, for generating useful data and reports based on the platform usage and analyses. In some embodiments, the intelligence layer 150 may include one or more of reporting module, statistics, module, prediction module, optimization module, data processing module, simulation module, and more. This layer may use large data and machine learning algorithms to optimize the generated reports per customers' needs or requirements. It may, for example, try to find different patterns to be able to recognize different events in real time, in order to generate relevant event(s) per customer requirements. The OSSSN may also collect external information in order to validate the stored information and to find the appropriate correlation to be able to generate accurate predictions.

According to some embodiments, a manager module or dashboard 160 is provided, integrated into interface layer 140, to enable users to set options, determine preferences and otherwise manage their Things, communities, connections, accounts, settings, system tools etc. In some embodiments an alert manager 162 is provided, to manage, configure and deliver warnings, messages or alerts to users or system admin.

According to some embodiments, channels or specialist interfaces 170 may be provided for selected user groups, for example, a government policy interface 172 may be provided by allowing streamlined handling and management of the OSP for a government, municipality etc. In a further example, a corporate or business policy interface 174 may be provided by allowing streamlined handling and management of the OSP for a business or organizational etc. In an additional example, a private interface 176 may be provided.

According to some embodiments, the sensor management system may include a security layer that includes one or more of API Encryption, OSP decryption, Hijack prevention, Secured Platform, and Automatic Backup for any data source. For example, the system may include decryption engine 180.

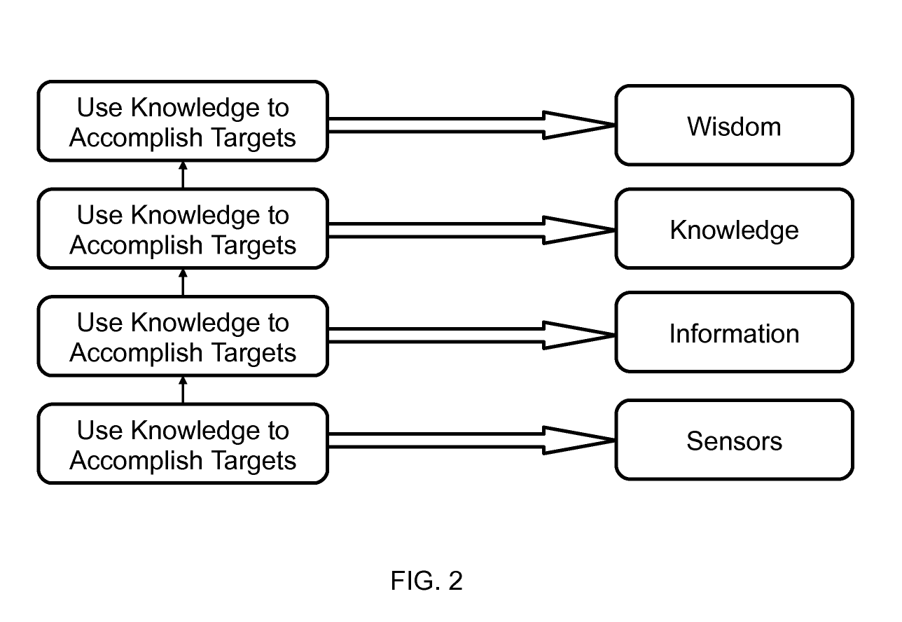

Reference is now made to FIG. 2, which shows a schematic relationship of OSSSN layers and functionalities. As can be seen, raw data may be collected by the ‘Things’ layer. Information may then be processed to derive “meaning” or value by analyzing the raw data, in the information layer. In the knowledge layer, the data may be analyzed and synthesized, whereas in the wisdom layer, the knowledge may be utilized to achieve specific goals or aims.

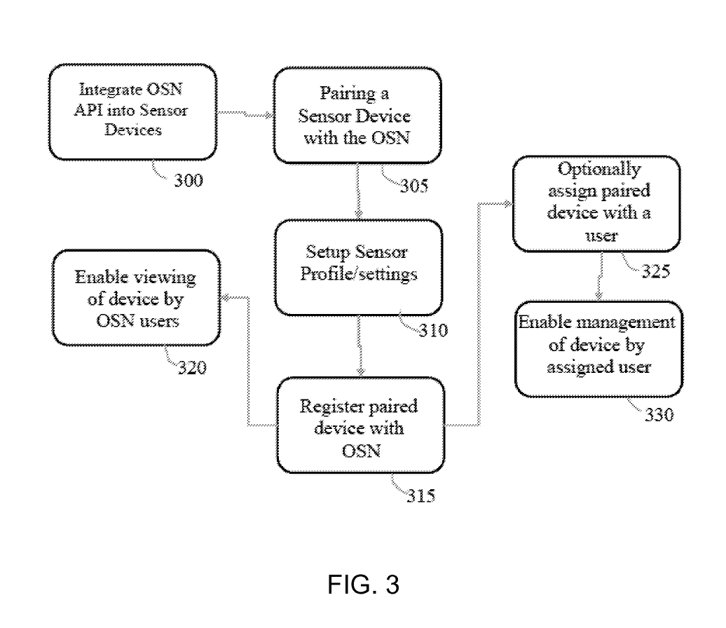

Reference is now made to FIG. 3, which is a flow diagram indicating the process by which a sensor may be setup in order to connect in into a open social smart sensor network, according to some embodiments. As can be seen in the figure, at step 300, an OSN API may be integrated into a sensor, thereby enabling the sensor for usage in the OSN. At step 305 an enabled sensor device is paired to the OSN. At step 315 the paired device may be given a profile or otherwise setup. At step 320 the paired device is made viewable to network users, or selected users or groups of users, depending on its settings. At step 325, optionally, the paired device is assigned one or more owners or managers. At step 330 the identified device is managed or controlled by the owner(s), for example, enabling the owner or manager to integrate to Social networks (e.g. Facebook, Twitter, SMS, E-mail etc), configure events, market the device to potential users, attain revenue streams etc.

In further applications, the OSSSN will be able to make use of collected data to develop strategic decision making tools to support, for example, further business development and future investment decisions. Accordingly, OSSSN may, in some embodiments, be adapted to provide sector or segment specific platform solutions. For example:

Government & Municipalities—solution for a wide area to be able operate an Open-Social-Sense platform with a variety of back office services including monitoring real-time sensors, alarms management, scenario analysis, Mobile applications etc.

Business level—solution for mid-to-large size businesses to operate a smart Open-Sense platform with a variety of services.

Customer level—solution customized specifically for citizens and small business. (Kits for self-installing)

The above described OSP technology lead will allow for ease of deployment, design simplicity, reliability, operational integrity and maintainability. The OSP may integrate different interfaces to enable the platform to integrate with different types of services, such as billing systems, security systems etc.

The OSP enables users to fully monitor any smart sensor network using a fully integrated, full solution on a single vendor platform.

In accordance with some embodiments, assigned sensors may be structured or configured to supply data upon payment of an end user, thereby bringing revenues to the sensor's owner or manager. For example, a sensor may be configured to be publicly available for all to see, private for only selected users only, and/or selectively open to subscribers, for example paying users. In one example, a sensor owner may define a price to be paid for access to their sensor, such that only users that have paid for the sensor data may access the data.

The foregoing description of the embodiments of the invention has been presented for the purposes of illustration and description. It is not intended to be exhaustive or to limit the invention to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the invention.

What is claimed is:

1. A method for universal sensor communication, comprising:
Configuring multiple sensor devices with an open platform API;
Configuring multiple sensor gateways with an open platform API;
Setting up a sensor integration layer adapted to consolidate API related data from said sensors and/or sensor gateways;
processing consolidated API data by an Open Sensor Platform (OSP) and providing said data to system users, via a user interface.

2. The method of claim 1, further comprising communicating between system users and connected sensor devices.

3. The method of claim 1, further comprising communicating between connected sensor devices.

4. The method of claim 1, wherein said OSP is designed to connect multiple sensor devices in an entity, thereby enabling Smart entity functionality by facilitating remote sensor data interaction.

5. A method for sensor management, comprising:
connecting to an open sensor platform multiple sensor devices, using open platform APIs, wherein each sensor is provided with a sensor profile;
connecting to said open sensor network multiple users, using an open sensor platform user interface;
providing a user dashboard wherein users can determine platform settings;
enabling each platform user to connect to each connected sensor, upon choice of such a sensor profile.

6. The sensor management method of claim 5, wherein an end user pays money to make use of a sensor's data.

7. The sensor management method of claim 5, wherein an end user pays money to connect one or more sensors to the platform.

8. The sensor management method of claim 5, wherein a user pays money to access data from one or more sensors.

9. The sensor management method of claim 5, wherein an end user may use platform tools to promote a selected sensor profile.

10. The sensor management method of claim 5, wherein an end user pays money to promote a selected sensor profile.

11. The sensor management method of claim 5, wherein a sensor profile is displayed to the platform users in relation to the sensor's popularity.

12. The sensor management method of claim 5, wherein sensors can communicate to one another.

13. A smart sensor management system, comprising:
multiple sensor devices, each device being configured with an open platform API;
an Open Sensor Platform (OSP) for connecting the respective sensors into the smart sensor management system, and for enabling users of the system to communicate with the respective sensors using a sensor communication protocol;
an API integration layer for consolidating the API data from the respective sensors;
an interface layer for providing system users with an interface to interact with the system.

14. The sensor management system of claim 13, further comprising a communication protocol being adapted to run in association with the open platform API to interface with the OSP.

15. The sensor management system of claim 13, wherein the communication protocol is adapted to enable Auto provision to feed data to the system without a user profile.

16. The sensor management system of claim 13, wherein the communication protocol enables a user to take ownership of sensor data by identifying as the Sensor owner.

17. The sensor management system of claim 13, further comprising a security layer that includes one or more of API Encryption, OSP decryption, Hijack prevention, Secured Platform, and Automatic Backup for any data source.

18. The sensor management system of claim 13, further comprising External API's enabled to integrate external platforms including one or more of billing systems, Asset Management systems, purchasing systems, inventory tracking systems, transportation systems, weather tracking systems, and communication systems.
